(19) United States
(12) Patent Application Publication
(10) Pub. No.: US 2013/0234900 A1
(43) Pub. Date: Sep. 12, 2013

(54) TERMINAL INCLUDING ANTENNA

(71) Applicant: PANTECH CO., LTD., Seoul (KR)

(72) Inventor: Joo Sung KIM, Seoul (KR)

(73) Assignee: PANTECH CO., LTD., Seoul (KR)

(21) Appl. No.: 13/711,082

(22) Filed: Dec. 11, 2012

(30) Foreign Application Priority Data
Mar. 8, 2012 (KR) 10-2012-0023956

(51) Int. Cl. H01Q 5/01

(52) U.S. Cl. CPC H01Q 5/01
USPC 343/729

(57) ABSTRACT

Provided is a terminal including an antenna apparatus capable of securing a wideband characteristic in a multiple input multiple output (MIMO) antenna system. The antenna apparatus may include a band pass filter for blocking or reducing interference from another antenna apparatus. The antenna apparatus may maintain a resonant frequency band to be wide by forming a sub resonance using a plurality of uneven shapes.

### CROSS-REFERENCE TO RELATED APPLICATION

This application claims priority from and the benefit of Korean Patent Application No. 10-2012-0023956, filed on Mar. 8, 2012, which is hereby incorporated by reference for all purposes as if fully set forth herein.

### BACKGROUND

1. Field

Exemplary embodiments of the present invention relate to a terminal including an antenna.

2. Discussion of the Background

A terminal may need to support a plurality of communication systems using different frequency bands. An antenna apparatus included in the terminal may be designed to resonate in a relatively wide frequency band.

The introduction of multiple input multiple output (MIMO) technology has enabled a plurality of antenna apparatuses to be installed in a terminal. However, due to a limited size of the terminal, the plurality of antenna apparatuses may not be sufficiently spaced apart from each other. Accordingly, due to an interference signal from another antenna apparatus, a frequency characteristic of an antenna apparatus may be degraded.

To install a wideband characteristic and a desired MIMO antenna system in a terminal, there is a desire for an antenna apparatus that may minimize interference between antennas and thereby secure a wideband characteristic.

### SUMMARY

Exemplary embodiments of the present invention provide a terminal with antenna.

Exemplary embodiments of the present invention also provide a terminal including an antenna that may secure a wideband characteristic using multiple resonances and may block or reduce an interference signal from another antenna using a band pass filter.

Additional features of the invention will be set forth in the description which follows, and in part will be apparent from the description, or may be learned by practice of the invention.

An exemplary embodiment of the present invention disclose a terminal including a first antenna apparatus, the terminal including: a first antenna pattern including: a first coupling element connected to a ground, the first coupling element comprising a first shape and a second shape; and a first radiation unit configured to transmit and receive a signal in a first frequency band, wherein the first frequency band is determined according to an inductance value of a first band pattern and a capacitance formed between the first shape and the second shapes.

An exemplary embodiment of the present invention also discloses a terminal comprising a first antenna and a second antenna that operate in a first frequency band and a second frequency band, respectively, the first antenna including: a first antenna pattern to resonate in the first frequency band; a second antenna pattern to resonate in the second frequency band; and a first band pass filter configured to attenuate frequencies outside the first frequency band.

An exemplary embodiment of the present invention also discloses an antenna apparatus of a terminal, including: a first antenna pattern configured to resonate in a first frequency band; and a first coupling element including two uneven shapes and included in the first antenna pattern, wherein the first frequency band is determined according to a capacitance formed between the two uneven shapes and an inductance value of the first antenna pattern.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an antenna structure according to an exemplary embodiment of the present invention.

FIG. 2 is a diagram illustrating an antenna structure according to an exemplary embodiment of the present invention.

FIG. 3A is a graph illustrating antenna performance according to an exemplary embodiment of the present invention.

FIG. 3B is a graph illustrating antenna performance according to an exemplary embodiment of the present invention.

FIG. 4 is a block diagram illustrating a terminal according to an exemplary embodiment of the present invention.

FIG. 5 is a block diagram illustrating a terminal according to an exemplary embodiment of the present invention.

FIG. 6 is a block diagram illustrating a terminal according to an exemplary embodiment of the present invention.

FIG. 7A is a diagram illustrating radiation patterns of a multiple input multiple output (MIMO) antenna system according to an exemplary embodiment of the present invention.

FIG. 7B is a diagram illustrating radiation patterns of a MIMO antenna system according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element is referred to as being “directly on” or “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Although features may be described with respect to one exemplary embodiment, aspects need not be limited thereto such that features of exemplary embodiments may be combined and/or applied to other exemplary embodiments.

Hereinafter, exemplary embodiments of the present invention will be described with reference to the accompanying drawings.

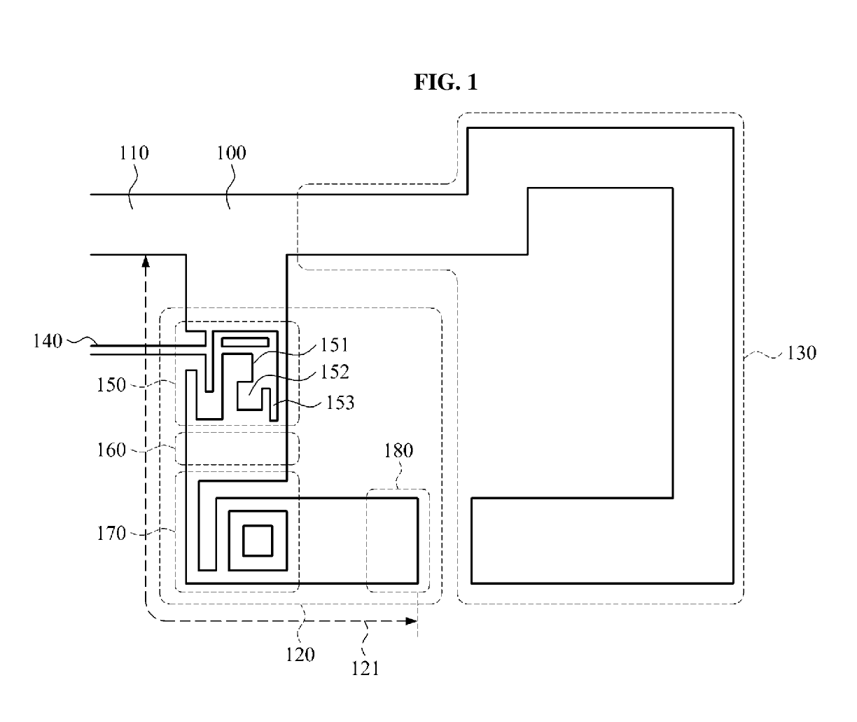

FIG. 1 is a diagram illustrating an antenna according to an exemplary embodiment of the present invention.

An antenna apparatus 100 may be configured to radiate a signal converted to a high frequency band and a low frequency band, or may receive a signal of a high frequency band that is radiated from another apparatus. The antenna apparatus 100 may resonate in a frequency band of a signal to be transmitted or received. The frequency band may be referred to as a resonant frequency band. A size and a shape of the antenna apparatus 100 may be determined based on the resonant frequency band.

The antenna apparatus 100 may include a feeding unit 110 to provide power. Referring to FIG. 1, the antenna apparatus 100 may include a high band pattern 120 configured to use a high frequency band as resonant frequency band and a low band pattern 130 configured to use a low frequency band as a resonant frequency band. The high band pattern 120 and the low band pattern 130 may individually or collectively be referred to as an antenna pattern. A resonant frequency band of the low band pattern 130 may correspond to a frequency band between 700 MHz and 960 MHz, and may be a frequency band used in long term evaluation (LTE)/code division multiple access (CDMA)/global system for mobile communication (GSM) 850/G900/wide code division multiple access (WCDMA) 850/WCDMA900, and the like. A resonant frequency band of the high band pattern 120 may correspond to a frequency band between 1700 MHz and 2170 MHz, and may be a frequency band used in DCS 1800/personal communication services (PCS) 1900/US PCS/WCDMA, and the like.

A coupling element 150 may be included in the high band pattern 120. The coupling element may be disposed adjacent to the low band pattern 130.

The coupling element 150 may include at least one uneven shape, for example, uneven shape 151, uneven shape 152, and uneven shape 153, and may be connected to a ground 140. The “uneven shape” may be any random shape. The uneven shape may have straight edges or curved edges. The uneven shape may include acute angles, obtuse angles, or perpendicular angles. Each uneven shape may have a different shape and/or size from each of the other uneven shapes or may be similarly shaped and/or sized. Although described as “uneven” the shape of the uneven shape 151, the uneven shape 152, and the uneven shape 153, may be even, i.e., symmetrical with respect to at least one view thereof. Further, the uneven shape 151, the uneven shape 152, and the uneven shape 153 may include protrusions and/or indentations having themselves protrusions and/or indentations. Moreover, although FIG. 1 illustrates the three uneven shapes 151, 152, and 153, aspects need not be limited thereto such that the coupling element 150 may include any number of uneven shapes each having one of a various numbers of sides or edges. A shape and a length of the at least one uneven shape, for example, the uneven shape 151, the uneven shape 152, and the uneven shape 153 may be determined according to a resonant frequency band of the high band pattern 120. An uneven shape that is determined according to the resonant frequency band may be configured in various shapes.

Electric charge may fill in a space between uneven shapes, for example, the uneven shape 151, the uneven shape 152, and the uneven shape 153, and a capacitance may be virtually formed in the space. For example, a first capacitance may be formed in a space between the uneven shape 151 and the uneven shape 152, a second capacitance may be formed in a space between the uneven shape 152 and the uneven shape 153, and a third capacitance may be formed in a space between the uneven shape 151 and the uneven shape 153.

A length 121 of the high band pattern 120 may be determined according to the resonant frequency band of the high band pattern 120, and an inductance of the high band pattern 120 may be determined according to the length 121 of the high band pattern 120.

The resonant frequency band of the high band pattern 120 may be determined according to Equation 1:

$${f}_{n} = \frac{1}{2 π \sqrt{L \cdot {C}_{n}}} \qquad [ Equation 1 ]$$

Where, Cₙ denotes a value of capacitance formed between the respective uneven shape 151, uneven shape 152, and uneven shape 153, L denotes a value of inductance that is determined based on the length 121 of the high band pattern 120, and fₙ denotes a resonant frequency band according to the capacitance generated between each of the uneven shape 151, the uneven shape 152, and the uneven shape 153 and the inductance of the high band pattern 120. A resonance generated by one of a plurality of capacitance components that are generated by the respective uneven shape 151, the uneven shape 152, and the uneven shape 153 will be referred to as a “sub resonance,” and a resonant frequency band of the sub resonance will be referred to as a “sub resonant frequency band.”

Referring to Equation 1, the high band pattern 120 may form multiple resonances due to a plurality of capacitances formed by the uneven shapes 151, the uneven shape 152, and the uneven shape 153. In other words, a plurality of sub resonances may be formed. A sub resonant frequency band of each sub resonance may be determined based on a shape of each corresponding uneven shape.

The resonant frequency band of the high band pattern 120 may be a sum of sub resonant frequency bands and thus, the resonant frequency range may be large. Accordingly, the high band pattern 120 may have a wideband characteristic.

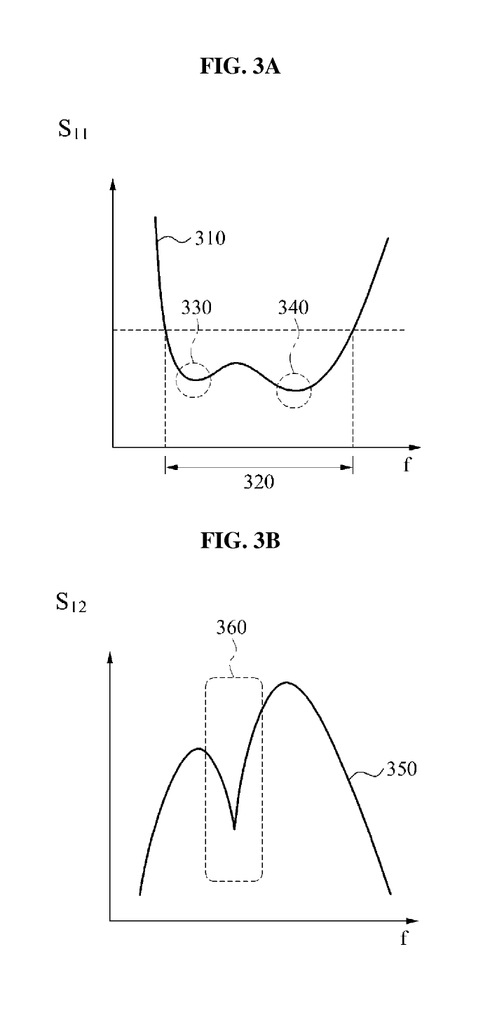

How a resonant frequency band may become wider due to a plurality of sub resonances will be described with reference to FIG. 3.

The high band pattern 120 may include a band pass filter 170. The band pass filter 170 may pass a signal of a reference frequency band and may block or reduce a signal of another frequency band. The band pass filter 170 may pass a signal by resonance and may block or reduce the signal from another radio frequency (RF) device, and may thereby improve a frequency characteristic of the resonant frequency band.

The high band pattern 120 may include at least one radiation unit, for example, a first radiation unit 180 and a second radiation unit 160. The first radiation unit 180 may be disposed at an end of the high band pattern 120 and may be a radiation unit that uses, as a resonant frequency band, a relatively low frequency band among resonant frequency bands of the high band pattern 120. The second radiation unit 160 may be disposed in the middle of the high band pattern 120 and may be a radiation unit that uses, as a resonant frequency band, a relatively high frequency band among the resonant frequency bands of the high band pattern 120.

The band pass filter 170 may be designed to pass a signal corresponding to the resonant frequency band of the first radiation unit 180 to pass, and to block or reduce a signal corresponding to the resonant frequency band of the second radiation unit 160. The signal corresponding to the resonant frequency band of the first radiation unit 180 may pass the band pass filter 170 and thereby be radiated using the first radiation unit 180. However, the signal corresponding to the resonant frequency band of the second radiation unit 160 may not pass the band pass filter 170. Accordingly, a frequency characteristic of the antenna apparatus may improve in the resonant frequency band of the first radiation unit 180.

The antenna apparatus 100 of FIG. 1 may operate together with other antennas. For example, even though not illustrated in FIG. 1, the antenna apparatus 100 may operate as a portion of a multiple input multiple output (MIMO) antenna system together with another antenna apparatus. The antenna apparatus 100 may receive interference from the other antenna apparatus.

The band pass filter 170 may be a high frequency device that is designed to pass a signal of a reference frequency band there through and to block or reduce a signal of another frequency band. The band pass filter may attenuate frequencies outside of the frequency band.

The band pass filter 170 may pass a resonant frequency band of the antenna apparatus 100 and may block or reduce an interference signal from another antenna apparatus. Accordingly, the band pass filter 170 may improve a frequency characteristic of the antenna apparatus 100 by blocking or reducing interference from the other antenna apparatus.

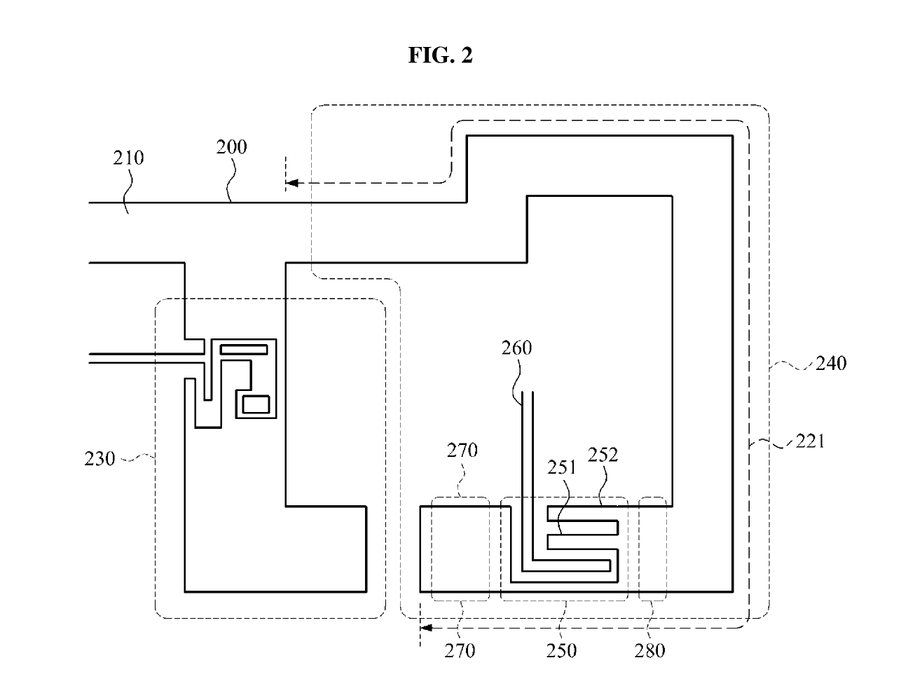

FIG. 2 is a diagram illustrating an antenna structure according to an exemplary embodiment of the present invention.

An antenna apparatus 200 may include a feeding unit 210 to provide power.

Referring to FIG. 2, the antenna apparatus 200 may include a high band pattern 230 configured to use a high frequency band as a resonant frequency band and a low band pattern 240 configured to use a low frequency band as a resonant frequency band.

A resonant frequency band of the low band pattern 240 may correspond to a frequency band between 700 MHz and 960 MHz, and may be a frequency band used in LTE/CDMA/GSM850/G900/WCDMA850/WCDMA900, and the like. A resonant frequency band of the high band pattern 230 may correspond to a frequency band between 1700 MHz and 2170 MHz, and may be a frequency band used in DCS1800/PCS1900/US PCS/WCDMA, and the like.

The low band pattern 240 may include a coupling element 250. The coupling element 250 may include at least one uneven shape, for example, uneven shape 251 and uneven shape 252, and may be connected to a ground 260. A shape and an interval of the at least one uneven shape, for example, the uneven shape 251 and the uneven shape 252, may be determined based on a resonant frequency band of the low band pattern 240. The “uneven shape” may be any random shape. The uneven shape may have straight edges or curved edges. The uneven shape may include acute angles, obtuse angles, or perpendicular angles. Each uneven shape may have a different shape and/or size from each other uneven shapes or may be similarly shaped and/or sized. Although described as “uneven” the shape of the uneven shape 251 and the uneven shape 252 may be even, i.e., symmetrical with respect to at least one view thereof. Further, the uneven shape 251 and the uneven shape 252 may include protrusions and/or indentations having themselves protrusions and/or indentations. Moreover, although FIG. 2 illustrates the two uneven shapes 251 and 252, aspects need not be limited thereto such that the coupling element 250 may include any number of uneven shapes each having one of a various numbers of sides or edges. An uneven shape that is determined according the resonant frequency band may be configured in various shapes.

The high band pattern 230 may include a coupling element. The coupling element may include at least one uneven shape and may be connected to a ground. A shape and an interval of the at least one uneven shape, may be determined based on a resonant frequency band of the high band pattern 230. The “uneven shape” may be any shape. The uneven shape may have straight edges or curved edges. The uneven shape may include acute angles, obtuse angles, or perpendicular angles. If more than one uneven shape is included in the coupling element, each uneven shape may have a different shape and/or size from each other uneven shapes or may be similarly shaped and/or sized. Although described as “uneven” the shape of the may be even, i.e., symmetrical with respect to at least one view thereof. An uneven shape that is determined according the resonant frequency band may be configured in various shapes. Further, each of or one of the high band pattern 230 and the low band pattern 240 may include coupling elements including uneven shapes.

An electric charge may be formed in a space between uneven shapes, for example, the uneven shape 251 and the uneven shape 252, and a capacitance may be virtually formed in the space. For example, a plurality of capacitance components may be formed in the space between the uneven shape 251 and the uneven shape 252. A capacitance value may be determined according to a shape of each corresponding uneven shape.

A length 221 of the low band pattern 240 may be determined according to the resonant frequency band of the low band pattern 240, and an inductance of the low band pattern 240 may be determined according to the length 221 of the low band pattern 240.

Each of a capacitance formed by the uneven shape 251 and the uneven shape 251 and the inductance of the low band pattern 240 may form a sub resonance. A plurality of sub resonances may constitute the resonant frequency band of the low band pattern 240. Since a plurality of sub resonances may be formed, the resonant frequency band of the low band pattern 240 may become wide and the low band pattern 240 may have a wideband characteristic.

Although not illustrated in FIG. 2, the low band pattern 240 may include a band pass filter. The band pass filter may improve a frequency characteristic of the low band pattern 240 by blocking or reducing a signal corresponding to a resonant frequency band of the high band pattern 230. If the antenna apparatus 200 operates as a portion of a MIMO antenna system together with another antenna apparatus, the band pass filter may improve a frequency characteristic of the antenna apparatus 200 by blocking or reducing an interference signal from the other antenna apparatus.

If the antenna apparatus 200 includes a plurality of radiation units, for example, a first radiation unit 270 and a second radiation unit 280, the band pass filter may be disposed between the first radiation unit 270 and the second radiation unit 280. The band pass filter may pass a signal corresponding to a resonant frequency band of the first radiation unit 270 that may be disposed at one end of the low band pattern 240 to pass there through and may block or reduce a resonant frequency band of the second radiation unit 280. A frequency characteristic may be improved in the resonant frequency band of the first radiation unit 270.

FIG. 3A is a graph illustrating antenna performance according to an exemplary embodiment of the present invention. FIG. 3B is a graph illustrating antenna performance according to an exemplary embodiment of the present invention.

Here, a parameter S may refer to a ratio of output voltage to input voltage in the frequency distribution. Numbers in the parameter S denote an input port and an output port, respectively. For example, S11 indicates an amount of power that is input to number 1 port and output to number 1 port.

If only an input port is present in an antenna, a parameter indicating an antenna characteristic may be the parameter S11.

If a value of S11 is large, it may indicate that a large amount of voltage input to an input port of an antenna is reflected to the input port again. In contrast, if a value of S11 is small, it may indicate that most of voltage input to the input port of the antenna is radiated outside an antenna. If S11 has a small value in a resonant frequency band of the antenna, and a value of S11 is small over the wide range, the antenna may be regarded as having a wideband characteristic.

FIG. 3A depicts S11 corresponding to one of a parameter of an antenna apparatus according to exemplary embodiments across a frequency band.

Referring to FIG. 3A, the antenna apparatus may form a sub resonance 330 and a second sub resonance 340 due to a plurality of capacitances. A curve 310 depicts a value of S11 may be maintained is low over a resonant frequency band 320. As a result, the antenna apparatus may secure the wide resonant frequency band 320.

FIG. 3B depicts S12 corresponding to one of a parameters of an antenna apparatus according to exemplary embodiments across a frequency band. If the antenna apparatus operates as a portion of a MIMO antenna system together with another antenna apparatus, a first port may indicate an input port of an antenna and a second port may indicate a virtual port via which interference transmitted from a first antenna to a second antenna is output. A curve 350 of S12 may depict the effect of interference that is received by the antenna apparatus from the other antenna apparatus or the effect of interference that is transmitted from the antenna apparatus to the other antenna apparatus.

If a value of S12 is large, it may indicate that a large portion of voltage input to an input port of an antenna is transmitted to another antenna and thus, the effect of inter-antenna interference may be great. In contrast, if a value of S12 is small, it may indicate that a small portion of voltage input to the input portion of the antenna is transmitted to the other antenna and thus, the effect of inter-antenna interference is small.

Referring to FIG. 3B, if a band pass filter is inserted into the antenna apparatus it may block or reduce an interference signal from another antenna apparatus in a resonant frequency band 360 of the antenna apparatus. Accordingly, the effect of inter-antenna interference may decrease in the resonant frequency band 360, and S12 may have a small value in the resonant frequency band 360. If inter-antenna interference is blocked or reduced in a MIMO communication environment, the antenna radiation performance may increase and the performance of the MIMO antenna system may also increase.

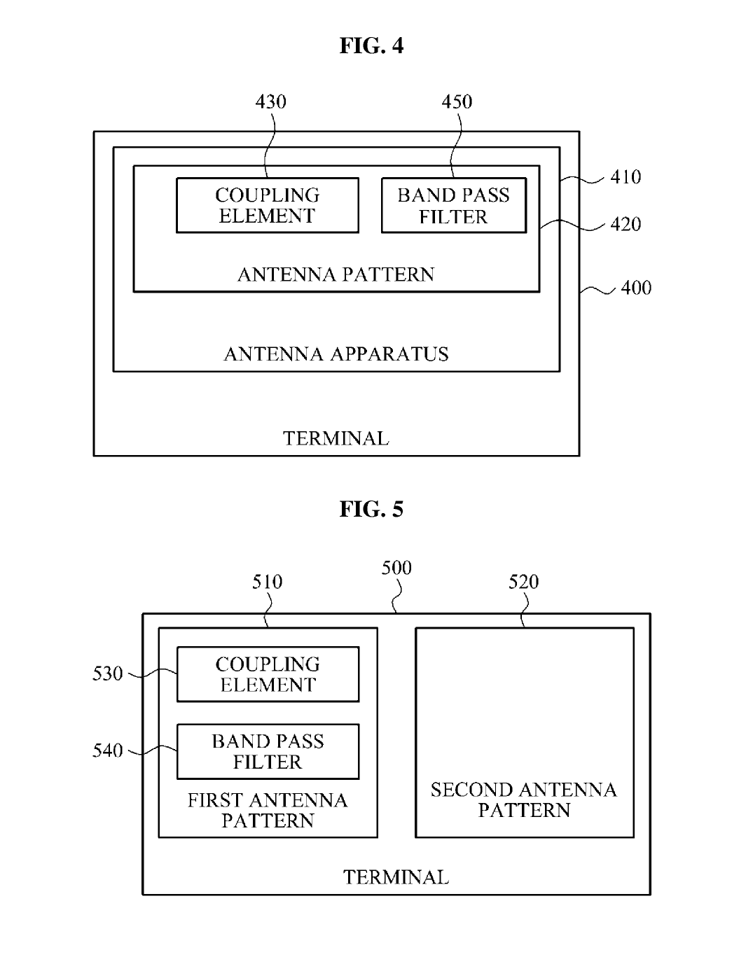

FIG. 4 is a block diagram illustrating a terminal according to an exemplary embodiment of the present invention.

The terminal 400 may include an antenna apparatus 410. Using the antenna apparatus 410, the terminal 400 may radiate or receive a signal of a frequency band that is included in a resonant frequency band of the antenna apparatus 410.

The antenna apparatus 410 may include at least one resonant frequency band. The antenna apparatus 410 may include an antenna pattern 420 corresponding to each resonant frequency band.

A length of the antenna pattern 420 may be determined according to an inductance of the antenna pattern 420 that is determined according to a resonant frequency band.

The antenna pattern 420 may include a coupling element 430. The coupling element 430 may include at least one uneven shape and may be connected to a ground. The coupling element 430 may be disposed in the middle of the antenna pattern 420, but is not limited thereto. The coupling element 430 may be disposed at other positions of the antenna patter 420, for example, adjacent to one of the ends of the antenna pattern 420.

The uneven shape included in the coupling element 430 may virtually form a plurality of capacitances. The capacitance values of the plurality of capacitance components may be different from each other. The antenna apparatus 410 may resonate based on an inductance of the antenna pattern 420 and each capacitance value.

A resonance according to the inductance of the antenna pattern 420 and a single capacitance may be referred to as a sub resonance. If the capacitance values of the plurality of capacitances are different from each other, sub resonant frequency bands of sub resonances that are determined according to the plurality of capacitances may be different from each other. For example, a first capacitance and the inductance may resonate in a first sub resonant frequency band, and a second capacitance and the inductance may resonate in a second sub resonant frequency band.

A resonance of the antenna apparatus 410 may be a sum of sub resonances, and a resonant frequency band of the antenna apparatus 410 may be a sum of sub resonant frequency bands.

The antenna apparatus 410 may have a wideband characteristic according to a capacitance value that is determined according to a shape of an uneven shape of the coupling element 430 and a length of the antenna pattern 420.

The antenna pattern 420 may include a band pass filter 450. The band pass filter 450 may be disposed in the middle of the antenna pattern 420, but is not limited thereto. The band pass filter 450 may be disposed at other positions of the antenna pattern 420. The band pass filter 450 may block or reduce a signal of a frequency band that is not a resonant frequency band of the antenna pattern 420. For example, if the resonant frequency band of the antenna pattern 420 is a first frequency band, the band pass filter 450 may block or reduce a signal from a band different from the first frequency band, and there by it may improve a frequency characteristic of the antenna pattern 420.

The band pass filter 450 may block or reduce an interference signal from another antenna device. If the antenna apparatus 410 operates in the vicinity of the other antenna device, such as an RF device, the antenna apparatus 410 may receive an interference signal from the other antenna device. The band pass filter 450 may block or reduce an interference signal from the other antenna device, and may thereby improve a frequency characteristic of the antenna apparatus 410.

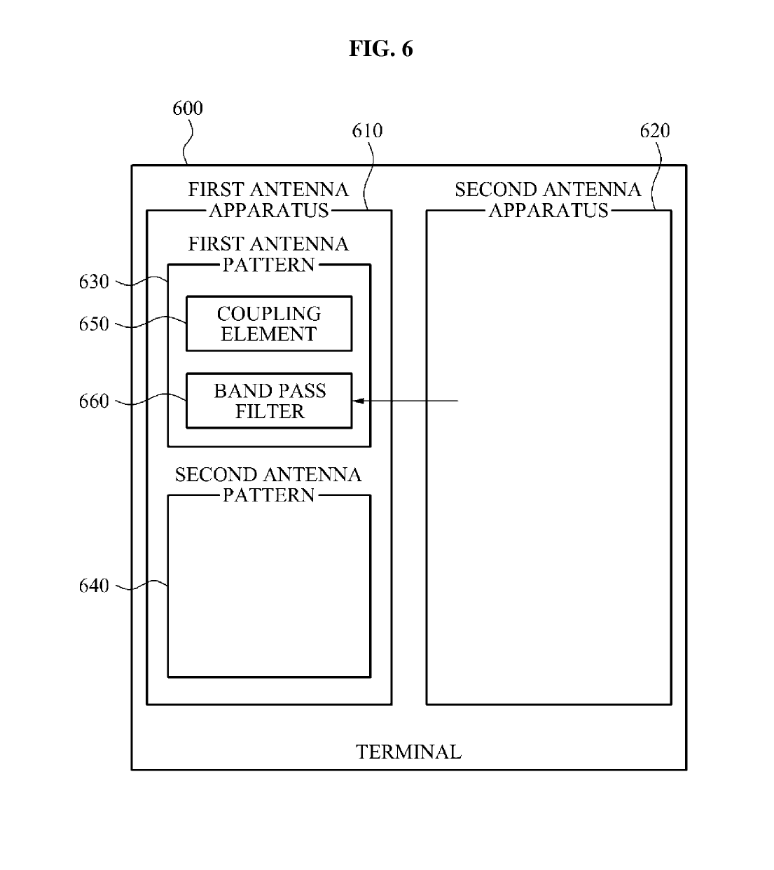

FIG. 5 is a block diagram illustrating a terminal according to an exemplary embodiment of the present invention.

The terminal 500 may include a first antenna pattern 510 and a second antenna pattern 520. A resonant frequency band of the first antenna pattern 510 may be a first frequency band, and a resonant frequency band of the second antenna pattern 520 may be a second frequency band. The resonant frequency band of the first antenna pattern 510 and the resonant frequency band of the second antenna pattern 520 may be different frequency bands. The terminal 500 may access a first communication system using the first frequency band and may access a second communication system using a second frequency band.

The first antenna pattern 510 may include a band pass filter 540. A signal of the second frequency band, i.e., the resonant frequency band of the second antenna pattern 520, may be input into the first antenna pattern 510. The band pass filter 540 may pass a signal of the first frequency band, i.e., the resonant frequency band of the first antenna pattern 510, to pass there through, and may block or reduce a signal of the second frequency band that is different from the first frequency band.

If the terminal 500 accesses the first communication system using the first antenna pattern 510, a signal of the first frequency band may be transmitted to the first communication system and a signal of the second frequency band may not be transmitted to the first communication system. Accordingly, a frequency characteristic of the terminal 500 may be enhanced.

The first antenna 510 may include a coupling element 530 including a plurality of uneven shapes. The coupling element 530 may be disposed in the middle of the first antenna 510 and may be connected to a ground, but is not limited thereto. The coupling element 530 may be disposed at other positions of first antenna 510, for example, adjacent to one of the ends of the first antenna 510. Also, the coupling element 530 may include at least one uneven shape.

A plurality of capacitances may be virtually formed between the first antenna 510 and the respective uneven shapes that are included in the coupling element 530. The first antenna pattern 510 may form an inductance component.

The first antenna pattern 510 may resonate in a first sub frequency band based on a first capacitance and the inductance, which is referred to as a first sub resonance. The second antenna pattern 520 may resonate in a second sub frequency band based on a second capacitance and the inductance, which is referred to as a second sub resonance. The resonant frequency band of the first antenna pattern 510 may be a sum of the first sub resonant frequency and the second sub frequency band.

The resonant frequency band of the first antenna pattern 510 may be determined based on a length and a shape of each uneven shape included in the coupling element 530, and the resonant frequency band of the first antenna pattern 510 may be a wideband. Each of the first antenna pattern 510 and the second antenna pattern 520 may include one, both, or neither of a coupling element and a band pass filter.

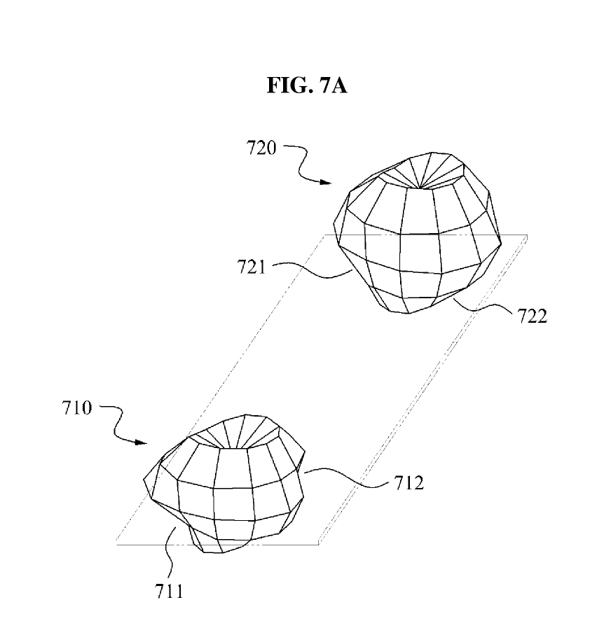

FIG. 6 is a block diagram illustrating a terminal according to an exemplary embodiment of the present invention.

The terminal 600 may include a plurality of antenna apparatuses, for example, a first antenna apparatus 610 and a second antenna apparatus 620. Each antenna apparatus may operate as a portion of a MIMO antenna system.

The first antenna apparatus 610 may include a first antenna pattern 630 configured to use a first frequency band as a resonant frequency band and a second antenna pattern 640 configured to use a second frequency band as a resonant frequency band.

The first antenna pattern 630 may include a coupling element 650 including a plurality of uneven shapes. The coupling element 650 may be disposed in the middle of the first antenna pattern 630 and may be connected to a ground, but is not limited thereto. The coupling element 650 may be disposed at other positions of the first antenna pattern 630. The coupling element 650 may include at least one uneven shape.

A plurality of capacitances may be virtually formed between the first antenna pattern 630 and each uneven shape that are included in the coupling element 650. The first antenna pattern 630 may resonate using each capacitance and an inductance formed by the first antenna pattern 630. The multiple resonances of the first antenna pattern 630 may be sum of a plurality of sub resonances. A resonant frequency band of the multiple resonances may be a sum of the sub resonant frequency bands. The first antenna pattern 630 may operate in a wide resonant frequency band using the coupling element 650.

The first antenna pattern 630 may include a band pass filter 660. If the first antenna apparatus 610 and the second antenna apparatus 620 operate as a portion of a MIMO antenna system, an interference signal from the second antenna apparatus 620 may be transferred to the first antenna apparatus 610. The band pass filter 660 may enhance an antenna characteristic of the first antenna apparatus 610 by blocking or reducing interference signal from the second antenna apparatus 620.

The band pass filter 660 may be disposed in the middle of the first antenna pattern 630, but is not limited thereto. The band pass filter 660 may be disposed at other positions of the first antenna pattern 630. If the first antenna pattern 630 is formed in a reference pattern on a printed circuit board (PCB), the band pass filter 660 and the coupling element 650 may also be formed on the PCB. The second antenna apparatus 620 may include at least one of a band pass filter and a coupler.

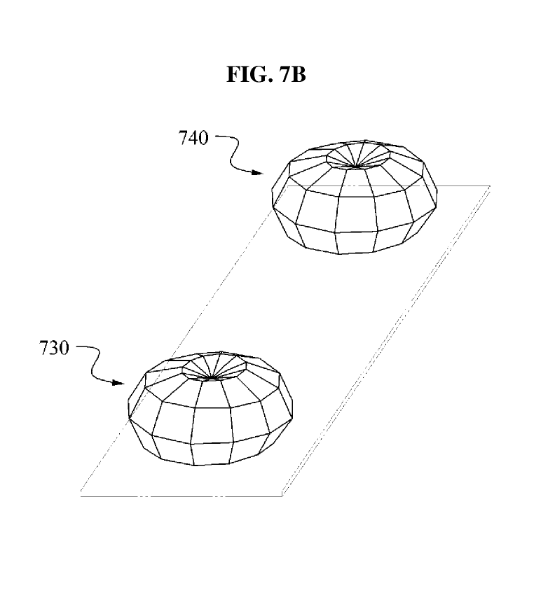

FIG. 7A is a diagram illustrating radiation patterns of a MIMO antenna system according to an exemplary embodiment of the present invention. FIG. 7B is a diagram illustrating radiation patterns of a MIMO antenna system according to an exemplary embodiment of the present invention.

A MIMO communication system is a system for improving a data transmission performance by transmitting data using a plurality of antennas. If the MIMO communication system is applied to a terminal, a plurality of antennas may be installed in a single terminal. Accordingly, the plurality of antennas may not be sufficiently spaced apart from each other to avoid potential interference with each other. For example, a signal to be transmitted using a first antenna may flow into a second antenna, and a signal to be transmitted using the second antenna may flow into the first antenna. Accordingly, the data transmission performance of the first antenna and the second antenna may be degraded.

FIG. 7A illustrates a radiation pattern 710 of a first antenna and a radiation pattern 720 of a second antenna if the first antenna and the second antenna interfere with each other. Portion 711, portion 712, portion 721, and portion 722 are dented portions of the radiation pattern 710 and the radiation pattern 720. The portion 711, the portion 712, the portion 721, and the portion 722 may be dented into a reference direction due to interference from the first antenna and the second antenna. A signal may not be radiated into the direction corresponding to each of the dented portion 711, the dented portion 712, the dented portion 721, and the dented portion 722, or an antenna may not receive a signal from the direction corresponding to each of the dented portion 711, the dented portion 712, the dented portion 721, and the dented portion 722.

FIG. 7B illustrates radiation pattern 730 and radiation pattern 740 of a MIMO antenna apparatus according to an exemplary embodiment of the present invention. According to an exemplary embodiment of the present invention, neighboring antenna apparatuses may block or reduce an interference signal from another antenna apparatus using a band pass filter inserted into a high band pattern or a low band pattern of the antenna apparatus.

The radiation pattern 730 and the radiation pattern 740 may have a substantially omnidirectional radiation pattern without distortions. Each antenna may radiate a signal in any direction or may receive a signal from any direction according.

The exemplary embodiments of the present invention may be recorded in non-transitory computer-readable media including program instructions to implement various operations embodied by a computer. The media may include, alone or in combination with the program instructions, data files, data structures, and the like. The media instruction and program instruction may be those specially designed and constructed for the purposes of the present invention, or they may be of the kind well-known and available to those having skill in the computer software arts.

According to exemplary embodiments of the present invention, it may be possible to secure the wideband performance of an antenna using multiple resonances.

According to exemplary embodiments of the present invention, it may be possible to reduce a terminal size by reducing interference between a plurality of antennas.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal including a first antenna apparatus, the terminal comprising:
a first antenna pattern comprising:
a first coupling element connected to a ground, the first coupling element comprising a first shape and a second shape; and
a first radiation unit configured to transmit and receive a signal in a first frequency band,
wherein the first frequency band is determined according to an inductance value of a first band pattern and a capacitance formed between the first shape and the second shape.

2. The terminal of claim 1, further comprising:
a first band pass filter configured to attenuate frequencies outside the first frequency band.

3. The terminal of claim 1, wherein the first antenna pattern further comprises a second radiation unit.

4. The terminal of claim 1, further comprising a second antenna pattern connected to the first antenna pattern.

5. The terminal of claim 1, wherein the first shape and the second shape are uneven shapes.

6. The terminal of claim 5, wherein the capacitance formed between the first shape and the second shape is a function of the shape of the uneven shapes.

7. The terminal of claim 4, wherein one of the first antenna pattern and the second antenna pattern is a low band pattern.

8. The terminal of claim 7, wherein the low band pattern is configured to operate in a frequency band in the range of 700 MHz to 960 MHz.

9. The terminal of claim 4, wherein one of the first antenna pattern and the second antenna pattern comprise a high band pattern.

10. The terminal of claim 9, wherein the high band pattern is configured to operate in a frequency band in the range of 1700 MHz to 2170 MHz.

11. The terminal of claim 4, wherein the second band pattern comprises:
a second coupling element connected to a ground, the second coupling element comprising a third shape and a fourth shape; and
a third radiation unit configured to transmit and receive a signal in the second frequency band,
wherein the second frequency band is determined according to a capacitance formed between the two shapes and an inductance value of the second band pattern.

12. The terminal of claim 11, wherein the second band pattern further comprises:
a second band pass filter configured to attenuate frequencies outside a second frequency band.

13. The terminal of claim 11, wherein the third frequency band and the second frequency band do not overlap.

14. The terminal of claim 11, wherein the second antenna pattern further comprises a fourth radiation unit.

15. The terminal of claim 11, wherein the third shape and the fourth shape are uneven shapes.

16. The terminal of claim 11, wherein the capacitance formed between the third shape and the fourth shape is a function of the shape of the uneven shapes.

17. An antenna apparatus of a terminal, comprising:
a first antenna pattern configured to resonate in a first frequency band; and
a first coupling element including two uneven shapes and included in the first antenna pattern,
wherein the first frequency band is determined according to a capacitance formed between the two uneven shapes and an inductance value of the first antenna pattern.

18. The antenna apparatus of claim 17, further comprising:
a first band pass filter configured to attenuate frequencies outside the first frequency band and included in the first antenna pattern.

19. The antenna apparatus of claim 17, further comprising: a radiation unit included in the first antenna pattern and configured to transmit and to receive a signal in the first frequency band.

20. The antenna apparatus of claim 17, further comprising a second antenna pattern configured to resonate in a second frequency band.

21. The antenna apparatus of claim 17, wherein the capacitance formed between the two uneven shapes is a function of the shape of the uneven shapes.

22. The antenna apparatus of claim 20, wherein one of the first antenna pattern and the second antenna pattern is a low band pattern and is configured to operate in a frequency band in the range of 700 MHz to 960 MHz.

23. The antenna apparatus of claim 20, wherein one of the first antenna pattern and the second antenna pattern is a high band pattern and is configured to operate in a frequency band in the range of 1700 MHz to 2170 MHz.

24. The antenna apparatus of claim 20, wherein the second antenna pattern comprises a second coupling element and a second band pass filter.

25. The antenna apparatus of claim 20, wherein the second frequency band and the first frequency band do not overlap.

26. A terminal comprising a first antenna and a second antenna that operate in a first frequency band and a second frequency band, respectively, the first antenna comprising:
a first antenna pattern to resonate in the first frequency band;
a second antenna pattern to resonate in the second frequency band; and
a first band pass filter configured to attenuate frequencies outside the first frequency band.

27. The terminal of claim 7, wherein the first antenna pattern comprises:
a first coupling element connected to a ground, the first coupling element comprising a first shape and a second shape; and
a first radiation unit configured to transmit and receive a signal in the first frequency s band,
wherein the first frequency band is determined according to an inductance value of the first band pattern and a capacitance formed between the first shape and the second shape.
